(19) United States
(12) Patent Application Publication
(10) Pub. No.: US 2009/0290957 A1
(43) Pub. Date: Nov. 26, 2009

(54) Fastener

(75) Inventor: Wen-Te Ho, Taichung (TW)

Correspondence Address: BACON & THOMAS, PLLC, 625 SLATERS LANE, FOURTH FLOOR, ALEXANDRIA, VA, 22314-1176, US

(73) Assignee: GRACE CHANCE ENTERPRISE CO., LTD,, Guangdong Province (CN)

(21) Appl. No.: 12/153,546

(22) Filed: May 21, 2008

(51) Int. Cl. F16B 15/00

(52) U.S. Cl. 411/490

(57) ABSTRACT

A fastener has a rod body that has a proximal end, a distal end, a head and an engaging segment. The head is formed on the proximal end. The engaging segment is formed between the proximal end and the distal end and has multiple teeth formed around the engaging segment. The rod body has a diameter gradually decreasing from the proximal end to the distal end. Accordingly, the fastener is convenient in combining two boards without using any tool.

### BACKGROUND OF THE INVENTION

1. Field of the Invention

The present invention relates to a fastener, and more particularly to a fastener that can combine two boards conveniently without using any tool.

2. Description of Related Art

A fastener, such as a bolt, a screw, a rivet or a nail is widely used for combing two boards. However, to combine two boards with a conventional fastener, a tool, such as a screwdriver or a hammer is necessary, so this is inconvenient. Without a specific tool, to combine two boards with a conventional is difficult and even impossible.

To overcome the shortcomings, the present invention tends to provide a fastener to mitigate or obviate the aforementioned problems.

### SUMMARY OF THE INVENTION

The main objective of the invention is to provide a fastener that is convenient in use without using any tool.

The fastener has a rod body that has a proximal end, a distal end, a head and an engaging segment. The head is formed on the proximal end. The engaging segment is formed between the proximal end and the distal end and has multiple teeth formed around the engaging segment. The rod body has a diameter gradually decreasing from the proximal end to the distal end.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a fastener in accordance with the present invention;

FIG. 2 is an operational exploded side view in partial section of the fastener in FIG. 1 being applied to combine two boards;

FIG. 3 is a side view in partial section of the boards with the fastener in FIG. 2;

FIG. 4 is an enlarged side view in partial section of the boards with the fastener in FIG. 3.

### DETAILED DESCRIPTION OF PREFERRED EMBODIMENT

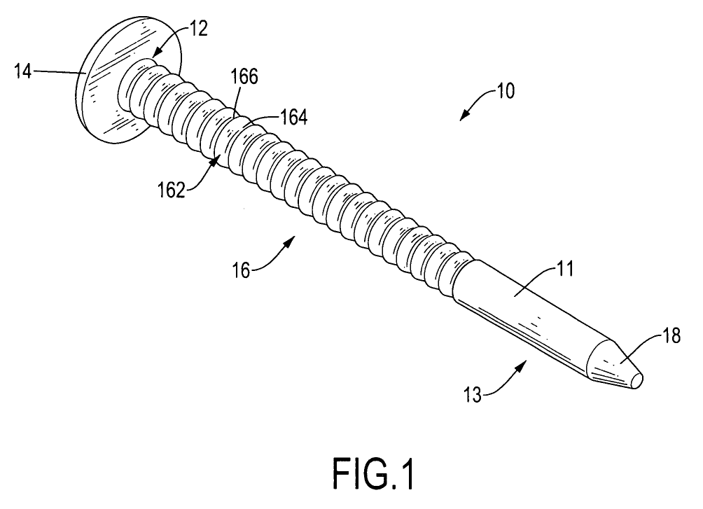

With reference to FIG. 1, a fastener (10) in accordance with the present invention is applied to combine two boards (30), such as plastic or wooden boards and has a rod body (11). The rod body (11) has a proximal end (12), a distal end (13), a head (14) and an engaging segment (16). The rod body (11) has a diameter gradually decreasing from the proximal end (12) to the distal end (13). In a preferred embodiment, the diameter on the proximal end (12) may be 3.5 millimeter (mm) and the diameter on the distal end (13) may be 2.8 millimeter (mm), or the diameter ratio between the two ends (12,13) may be 5:4.

The head (14) is formed on the proximal end (12) and has a diameter larger than that on the proximal end (12). A conical tip (18) is formed on and coaxially protrudes from the distal end (13). The engaging segment (16) is formed between the proximal end (12) and the distal end (13) and comprises multiple teeth (162) formed around the engaging segment (16) liking as bamboo joints. Each tooth (16) is conical around the rod body (11) and has an inclined surface (164) inclining toward the distal end (13) to form an annular engaging edge (166) facing the proximal end (12).

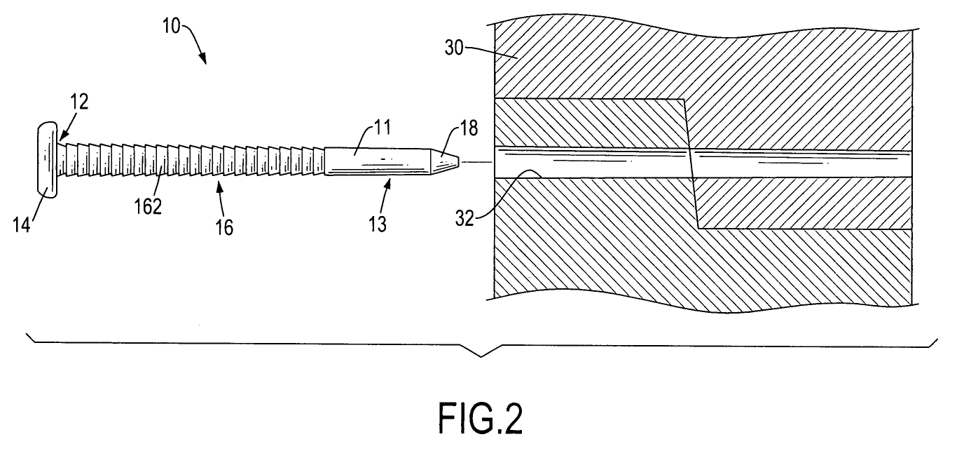

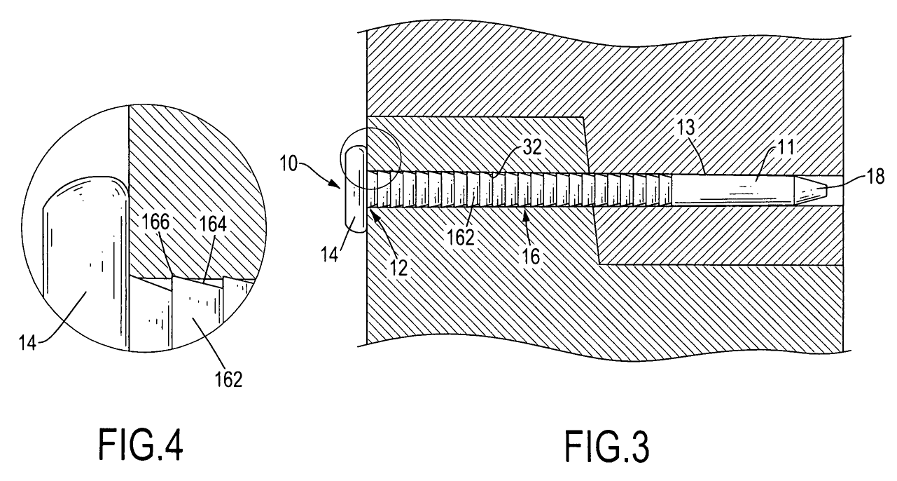

In use, with reference to FIGS. 2 to 4, to combine two boards (30), two holes (32) are defined through the boards (30) and align with each other, and the fastener (10) is aligned with and is pushed into the holes (32) in the boards (30) from the conical tip (18) on the distal end (13). Because the diameter on the distal end (13) is smaller than that on the proximal end (12) and the teeth (162) on the engaging segment (16) have inclined surfaces (164), the rod body (11) can be inserted into the holes (32) smoothly. After the rod body (11) being inserted into the holes (32), the teeth (162) on the engaging segment (16) will engage securely the inner surfaces of the holes (32) with the engaging edges (166). With the engagement between the engaging edges (166) on the teeth (162) with the inner surfaces of the holes (32), the fastener will not escape from the holes (32). Accordingly, the boards (30) are securely combined with each other with multiple fasteners (10).

With such a fastener (10) in accordance with the present invention, the fastener (10) can be pushed by fingers of a user and be conveniently inserted into the holes (32) in two boards (30) without using any tool. Accordingly, the fastener (10) in accordance with the present invention is convenient in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fastener having:
a rod body comprising
a proximal end;
a distal end;
a head formed on the proximal end; and
an engaging segment formed between the proximal end and the distal end and comprising multiple teeth formed around the engaging segment, wherein
the rod body has a diameter gradually decreasing from the proximal end to the distal end.

2. The fastener as claimed in claim 1, wherein each tooth is conical around the rod body and has an inclined surface inclining toward the distal end to form an annular engaging edge facing the proximal end.
